(19) United States
(12) Patent Application Publication
(10) Pub. No.: US 2002/0131645 A1
(43) Pub. Date: Sep. 19, 2002

(54) Method and apparatus for optimizing a JPEG image using regionally variable compression levels

(75) Inventor: Chris H. Hamilton, Kelowna (CA)

Correspondence Address: Hall, Priddy, Myers & Vande Sande, 200-10220 River Road, Potomac, MD, 20854, US

(73) Assignee: Packeteer Incorporated

(21) Appl. No.: 09/759,150

(22) Filed: Jan. 16, 2001

(51) Int. Cl. G06K 9/36; G06K 9/38

(52) U.S. Cl. 382/251

(57) ABSTRACT

A method of JPEG compression of an image frame divided up into a plurality of non-overlapping, tiled 8×8 pixel blocks Bᵢⱼ where i, j are integers covering all of the blocks in the image frame. A global quantization matrix Q is determined by either selecting a standard JPEG quantization table or selecting a quantization table such that the magnitude of each quantization matrix coefficient, Qᵢⱼ is inversely proportional to a visual importance, Iᵢⱼ, to the image of a corresponding DCT basis vector. Next a linear scaling factor Sᵢⱼ is selected which defines bounds over which the image is to be variably quantized. Transform coefficients, Dᵢⱼₘₙ, obtained from a digital cosine transform of Bᵢⱼ, are quantized and the quantized coefficients Tᵢⱼₘₙ and Q*Sₘᵢₙ are entropy encoded, where Sₘᵢₙ is a user selected minimum scaling factor, to create a JPEG image file. The algorithm is unique in that it allows for the effect of variable-quantization to be achieved while still producing a fully compliant JPEG file.

### FIELD

The present invention relates to a method and apparatus for optimizing a JPEG image using regionally variable compression levels.

### BACKGROUND

Compression is a useful method for reducing bandwidth consumption and download times of images sent over data networks. A variety of algorithms and techniques exist for compressing images. JPEG, a popular compression standard that is particularly good at compressing photo-realistic images, is in common use on the Internet. This standard, defined in “JPEG Still Image Data Compression Standard”, by W. B. Pennebaker and J. L. Mitchell, Chapman & Hall, 1992, is based on a frequency domain transform of blocks of image coefficients. As seen in FIG. 1, JPEG calls for subdividing an image frame 12 into 8×8 pixel blocks 11 and at box 16 transforming the array of pixel values in each block 11 with a discrete cosine transform (DCT) so as to generate 64 DCT coefficients corresponding to each pixel block 11. The coefficients for each block 11 are quantized in quantization block 20 using a 64 element quantization table 24. Each element of table 24 is an integer value from 1 to 255, which specifies the step size of the quantizer for the corresponding DCT coefficients. The quantized coefficients for each block are entropy encoded in entropy coding box 28, which performs a lossless compression. The entropy encoder 28 is coupled to the output of the quantizer 20 from which the former receives quantized image data. Standard JPEG entropy coding uses either Huffman coding or arithmetic coding using either predefined tables or tables that are computed for a specific image.

The JPEG compressed image data is decompressed by the bottom circuit of FIG. 1 by being first passed through an entropy decoder 30. Next inverse quantization in block 32 using quantization table 34 is performed. Finally the inverse DCT transform block 36 performs an inverse DCT operation to produce the image pixel intensity data.

More specifically, the discrete cosine transform block uses the forward discrete cosine function (DCT) to transform the image pixel intensity A(x, y) to DCT coefficients Yₘₙ as follows:

$${Y}_{mn} = 1 / 4 C ( m ) C ( n ) [ {\sum }_{x = 0}^{7} {\sum }_{y = 0}^{7} A ( x , y ) Cos \frac{( 2 x + 1 ) m π}{16} Cos \frac{( 2 y + 1 ) n π}{16} ]$$

where C(m) and C(n)=1/√2 for m, n=0, and C(m) and C(n)=1 otherwise.

The next step is to quantize the DCT coefficients using a quantization matrix, which is an 8×8 matrix of step sizes with one element for each DCT coefficient. A tradeoff exists between the level of image distortion and the amount of compression, which results from the quantization. A large quantization step produces large image distortion, but increases the amount of compression. A small quantization step produces lower image distortion, but results in a decrease in the amount of compression. JPEG typically uses a much higher step size for the coefficients, which correspond to high spatial frequency in the image, with little noticeable deterioration in the image quality because of the human visual system's natural high frequency rolloff. The quantization is actually performed by dividing the DCT coefficient Yₘₙ by the corresponding quantization table entry Qₘₙ and the result rounded off to the nearest integer according to the following:

Tₘₙ=round(Yₘₙ/Qₘₙ)

to give a quantized coefficient Tₘₙ. This type of quantizer is sometimes referred to as a midtread quantizer. An approximate reconstruction of Yₘₙ is effected in the decoder by multiplying Tₘₙ by Qₘₙ to obtain a reconstructed Yₘₙ. The difference between Yₘₙ and Yₘₙ represents lost image information causing distortion to be introduced. The amount of this lost information depends on the magnitude of Qₘₙ.

In the case of an image with multiple color channels, the aforementioned steps are applied in a similar fashion to each channel independently. In some cases, some of the color channels may be sub-sampled to achieve greater compression, without significantly altering the quality of the image reconstruction.

The quantization step is of particular interest since this is where information is discarded from the image. Ideally, one would like to discard as much information as possible, thereby reducing the stored image size, while at the same time maintaining or increasing the image fidelity. Within the standard there is no prescribed method of quantizing the image, but there is nonetheless a popular approach used in the software of the Independent JPEG Group (ISO/IEC JTC1 SC29 Working Group 1), and employed extensively by the general community. This method involves scaling a predetermined quantization table (calculated from statistical importance of basis vectors over a large set of images) by a factor dependent on a user-set quality, which lies in the range 1-100. This method yields good results on average, but is based on statistical averages over many images, and doesn't address global image characteristics, let alone local characteristics.

V. Ratnakar and M. Livny. “RD-OPT: An efficient algorithm for optimizing DCT quantization tables.” Proceedings DCC'95 (IEEE Data Compression Conference), pages 332-341, 1995 (and also U.S. Pat. No. 5,724,453) describe a rate-distortion dynamic programming optimization technique to reduce distortion for a given target bit-rate, or reduce bit-rate for a given target distortion. This reference uses “Mean Squared Error” as a measure of distortion and introduces some novel techniques for estimating bit-rate that improve the computational efficiency of the calculation. This algorithm is designed to calculate a single quantization table Q for each channel of the image, and it is based solely on global aggregate statistics. Also it does not take into account varying local image statistics. Moreover the method is computationally expensive. There exists another technique, which simultaneously optimizes the quantization and entropy encoding steps yielding a completely optimum JPEG file stream. This technique, however is extremely slow and unrealistic for real-time JPEG optimization.

U.S. Pat. No. 5,426,512 entitled “Image data compression having minimum perceptual error” uses a rate-distortion dynamic programming optimization technique to reduce distortion for a target bit-rate, or reduce bit-rate for a target distortion. This technique is very similar in concept to V. Ratnaker et al., except that the latter uses a “perceptual error” measure which attempts to mimic the eye's sensitivity to error. This algorithm is designed to calculate a single quantization table Q for each plane of the image, and it is based solely on global aggregate statistics, and it does not take into account varying local image characteristics.

U.S. Pat. No. 5,883,979 entitled “Method for selecting JPEG quantization tables for low bandwidth applications” is directed mainly at preserving text features in JPEG images at very low bit-rates. It uses image analysis based on global statistics to determine which DCT basis vectors are more visually important to the image, and weights them accordingly in the quantization table. Again, this algorithm is based on global statistics and also it is geared specifically for preserving textual data in JPEG images.

Ideally, one would like to have an optimal quantization fan table for every significantly different region of the image (a technique adopted for example in MPEG), which would then allow one to increase image fidelity as a function of file size; this technique of using different quantization tables for different areas of an image is generally referred to as variable quantization. In variable quantization, the figures of merit in question are image quality (distortion) and output file size (rate). The problem is then to decrease image distortion for a target rate, or to decrease rate for a target distortion. Of particular interest is the latter, since it has direct application in minimizing bandwidth usage for images which are sent over computer networks. This also reduces the time to transmit the image, which is important when the network path includes slow speed links.

It is preferred that any technique for quantizing an image also be computationally efficient, especially when the quantization is performed on images which are generated dynamically, or images which cannot be stored in a caching system. If the quantization is too slow, then any transmission time benefit realized from the reduction in rate is effectively annulled by the latency introduced in the quantization computation.

Accordingly, it is an object of the invention to provide a method for quantizing a JPEG image, which offers many of the benefits of variable quantization and is computationally efficient, while conforming to the widely used JPEG standard.

### SUMMARY OF THE INVENTION

According to the present invention there is provided a method, which is directed towards regionally variable levels of compression. The method is directed to JPEG compression of an image frame divided up into 8×8 pixel blocks Bᵢⱼ where i, j are integers covering all of the blocks in the image frame. The method includes forming a discrete cosine transform (DCT) of each block Bᵢⱼ of the image frame to produce a matrix of blocks of transform coefficients Dᵢⱼ. Next a visual importance, Iᵢⱼ, is calculated for each block of the image, based upon assigning zeros for flat features and values approaching unity for sharply varying features. A global quantization matrix Q is then formed such that the magnitude of each quantization matrix coefficient Qᵢⱼ is inversely proportional to a visual importance Iᵢⱼ of a corresponding DCT basis vector to the image. This local visual importance is used during the quantization stage, where for regions of lower detail, more data is discarded, resulting in more aggressive compression. In the quantization stage the transform coefficients are quantized by dividing them by a factor Sᵢⱼ Q, where Sᵢⱼ is a linear scaling factor, to create a JPEG image file. This algorithm is unique in that it allows for the effect of variable-quantization to be achieved while still producing a file which conforms to the JPEG standard.

The visual importance, Iᵢⱼ may be determined by discrete edge detection and summation of transform coefficients. This determination of I may include creating a 24×24 matrix of image pixels of DCT coefficients centered on a block Bᵢⱼ, where i and j=1, 2, . . . 8. The center 10×10 matrix of the 24×24 matrix may be convolved with an edge tracing kernel. The matrix values of the convolved matrix may be summed, and the summed value normalized to produce a visual importance, Iᵢⱼ.

The quantization matrix, Q, may be formed by calculating an 8×8 matrix A by calculating matrix elements Aₘₙ according to the formula:

$${A}_{{mn}_{V ( i , j )}} = \cdot {{I}_{ij} ( {B}_{ij} )}_{mn} .$$

Elements Qₘₙ of Q may then be calculated according to the formula:

Qₘₙ=max(Aₘₙ)/Aₘₙ

and scaling values of Qₘₙ for all values of (m, n) except (0, 0) in order to minimize the error between Q and a standard JPEG quantization matrix.

The linear scaling factor Sᵢⱼ may be set equal to lᵢⱼ (Sₘₐₓ−Sₘᵢₙ)+Sₘᵢₙ, where Sₘₐₓ and Sₘᵢₙ are user selected.

Quantizing the blocks of DCT coefficients Dᵢⱼ to produce quantized DCT coefficients Tᵢⱼₘ, where m and n refer to row and column, respectively, in each of the blocks may be accomplished by applying the formula.

Tᵢⱼₘₙ=round(Dᵢⱼₘₙ/(Sₘᵢₙ*Qₘₙ)),

where round denotes rounding to the nearest integer,

and if Tᵢⱼₘₙ>0

calculate round (Dᵢⱼₘₙ/(Sᵢⱼ*Qₘₙ)) and if equal to zero then set Tᵢⱼₘₙ=0, otherwise if

(abs(Dᵢⱼₘₙ)−(2ˆ (ceil(lg(abs(Dᵢⱼₘₙ)+1))−1)−1))<=abs(Dᵢⱼₘₙ−Qₘₙ*Sᵢⱼ*round(Dᵢⱼₘₙ/(Sᵢⱼ*Qₘₙ)))

then

Tᵢⱼₘₙ=sign(Dᵢⱼₘₙ)*(2ˆ (ceil(lg(abs(Dᵢⱼₘₙ)+1))−1)−1).

According to another aspect of the invention there is provided a method of JPEG compression of a colour image represented by channels Y for greyscale data, and U and V each for colour, which comprises shrinking the colour channels U and V by a fraction of their size, forming a discrete cosine transform (DCT) Dᵢⱼ for each block Bᵢⱼ of each of channels Y, U and V and calculating a visual importance, Iᵢⱼ, for each Y channel block of each image and setting Iᵢⱼ=max{Iᵢⱼ values for corresponding Y channel blocks} for blocks in the U and V channels. A global quantization matrix Q is formed for the Y channel block and one for channels U and V combined such that a magnitude of each quantization matrix coefficient Qᵢⱼ is inversely proportional to a visual importance Iᵢⱼ to the image of a corresponding DCT basis vector. Next the transform coefficients for each of the Y, U and V channels are quantized by dividing them by a factor Sᵢⱼ Q′, where Sᵢⱼ is a linear scaling factor for each of channels Y, U and V and Q′ is the quantization table for the associated channel being quantized. Finally, the quantized coefficients Tᵢⱼₘₙ and Q′*Sₘᵢₙ are entropy encoded, where Sₘᵢₙ is a user selected minimum scaling factor for each of channels Y, U, and V, to create a JPEG image file for each of channels Y, U and V.

Preferably, the shrinking factor is ½.

In another aspect of the invention there is provided an apparatus for JPEG compression of an image frame divided up into a plurality of non-overlapping, tiled 8×8 pixel blocks Bᵢⱼ where i, j are integers covering all of the blocks in the image frame. The apparatus includes a discrete cosine transformer (DCT) operative to form the deiscrete cosine transform of each block Bᵢⱼ of the image frame to produce a matrix of blocks of transform coefficients Dᵢⱼ, a visual importance calculator operative to calculate the visual importance, Iᵢⱼ, for each block of the image, based upon assigning zeros for flat features and values approaching unity for sharply varying features and a global quantization matrix calculator operative to calculate the global quantization matrix, Q, by one of

(i) selecting a standard JPEG quantization table and

(ii) selecting a quantization table such that the magnitude of each quantization matrix coefficient Qᵢⱼ is inversely proportional to the importance in the image of the corresponding DCT basis vector.

A linear scaling factor calculator determines a linear scaling factor, Sᵢⱼ, defining bounds over which the image is to be variably quantized based on user established values of Sₘₐₓ and Sₘᵢₙ. A quantizer is operative to divide the transform coefficients, Dᵢⱼₘₙ, by a value equivalent to dividing them by a factor Sₘᵢₙ*Q, where Sₘᵢₙ is a user selected minimum scaling factor, and an entropy encoder encodes the quantized coefficients Tᵢⱼₘₙ and Q*Sₘᵢₙ to create a JPEG image file.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a schematic diagram showing a conventional JPEG system;

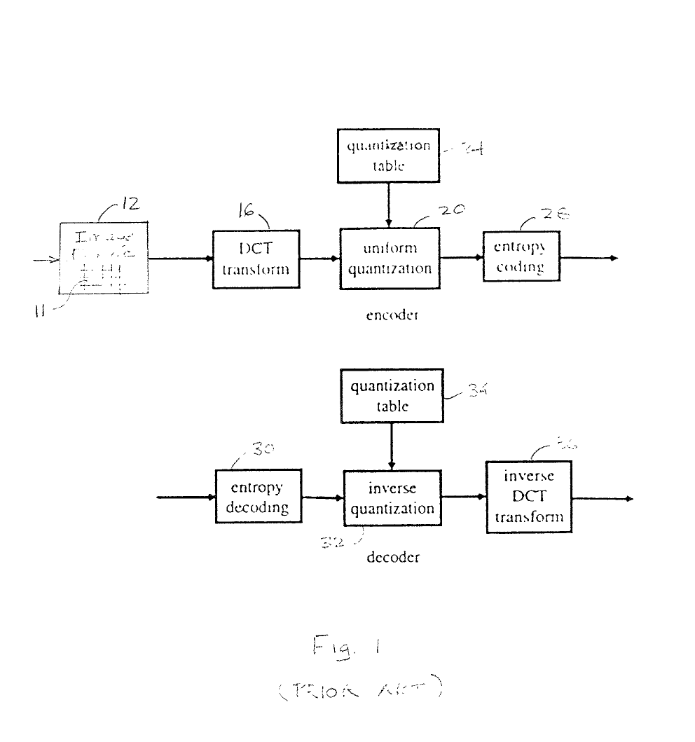

FIG. 2 is a flowchart showing the sequence of steps in the algorithm; and

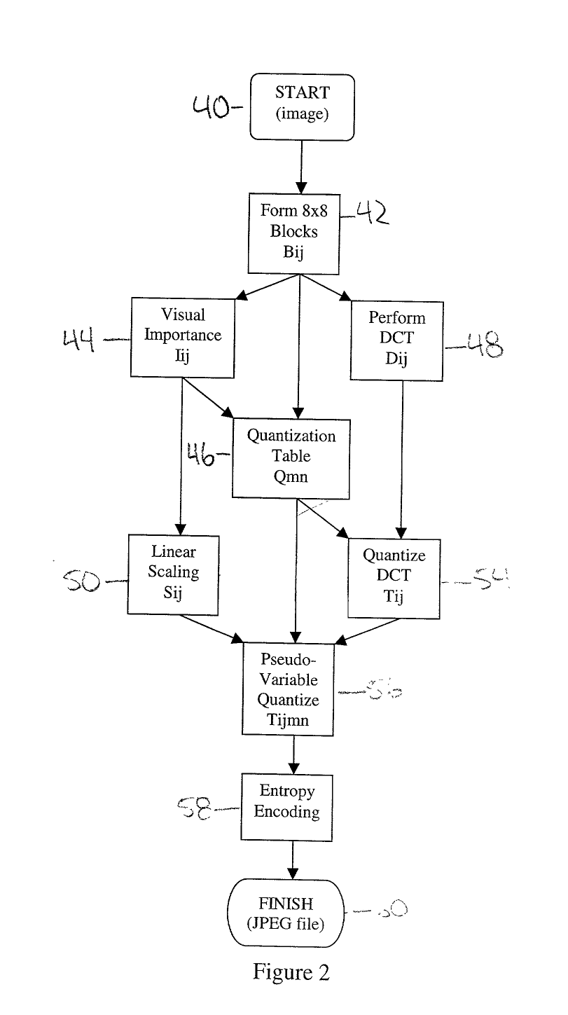

FIG. 3 is a schematic diagram of the JPEG image compressor.

### DETAILED DESCRIPTION WITH REFERENCE TO THE DRAWINGS

An image frame is selected at step 40. The image frame is divided into non-overlapping tiled 8×8 pixel blocks Bᵢⱼ at step 42 according to the JPEG standard.

For each 8×8 block Bᵢⱼ in the image frame, a visual image importance Iᵢⱼ is calculated at step 44. Note that the actual measure of visual importance is not important to the outline of the algorithm. The Iᵢⱼ values exhaustively cover the range [0, 1], and are a measure of how aggressively the block can be quantized. A value of Iᵢⱼ=0 indicates that the visual appearance of the block is rather insensitive to the level of quantization, and a value of Iᵢⱼ=1 indicates that the visual appearance of the block is very sensitive to the level of quantization.

One method of selecting the visual importance Iᵢⱼ is based on a discrete edge-detection and summation technique. Consider a 24×24 window Wᵢⱼ on the image defined by the nine image blocks, B_{i-1,j-1}, B_{i,j-1}, B_{i+1,j-1}, B_{i,j}, B_{i+1,j}, B_{i-1,j+1}, B_{i,j+1}, B_{i+1,j+1}. This window is centered around the block Bᵢⱼ. The nine blocks are shown graphically in the following diagram:

| | | |
|---|---|---|
| B_{i-1,j-1} | B_{i,j-1} | B_{i+1,j+1} |
| B_{i-1,j} | B_{i,j} | B_{i+1,j} |
| B_{i-1,j+1} | B_{i,j+1} | B_{i+1,j+1} |

From this 24×24 window, a 10×10 window Vᵢⱼ, centered about Bᵢⱼ, is then convolved with a standard Laplacian edge detection kernel G, to give Hᵢⱼ. The edge detection kernel employed is,

$$G = [ \begin{matrix}1 & 1 & 1 \\ 1 & - 8 & 1 \\ 1 & 1 & 1\end{matrix} ]$$

and the convolution is given by,

$${H}_{ij} = {\sum }_{m , n} {V}_{i - m , j - m} {G}_{ij}$$

This technique is essentially the discrete equivalent of taking the second derivative of the image in both dimensions. The output of the convolution Hᵢⱼ is scaled to cover an 8-bit range between 0 and 255, the same range taken by the actual pixels in the image. The convolved values are then summed, and the sum is divided by 100*255 to scale the sum to the range 0 to 1. This scaled sum is denoted as Kᵢⱼ. This sum is then renormalized using the following function:

$$Iij = \frac{Kij ( 100 + C )}{100 Kij + C}$$

where C is equal to 14. This function is determined statistically, and remaps the Kᵢⱼ values such that they lie on a normal distribution.

The above procedure is used to calculate Iᵢⱼ for each block in the image. The end result is a value for each Iᵢⱼ which is bounded on the region (0, 1), takes values of 0 for flat blocks, and values approaching 1 for blocks that have lots of sharp, short features (in other words have large second derivatives).

The quantization matrix Q is determined at step 46. In one approach, Q is simply set equal to the standard JPEG quantization table, which is in general use, by the community. An example of a suitable such matrix is the following:

| | | | | | | | |
|---|---|---|---|---|---|---|---|
| 16, | 11, | 10, | 16, | 24, | 40, | 51, | 61, |
| 12, | 12, | 14, | 19, | 26, | 58, | 60, | 55, |
| 14, | 13, | 16, | 24, | 40, | 57, | 69, | 56, |
| 14, | 17, | 22, | 29, | 51, | 87, | 80, | 62, |
| 18, | 22, | 37, | 56, | 68, | 109, | 103, | 77, |
| 24, | 35, | 55, | 64, | 81, | 104, | 113, | 92, |
| 49, | 64, | 78, | 87, | 103, | 121, | 120, | 101, |
| 72, | 92, | 95, | 98, | 112, | 100, | 103, | 99 |

In another approach, an image-specific quantization matrix is generated, where the magnitude of each quantization table coefficient is inversely proportional to the importance in the image of the corresponding basis vector.

One approach to generating an image-specific quantization matrix Q defines an 8×8 array such that each value Aₘₙ is equal to the sum of the corresponding coefficients (m, n) in each block Bᵢⱼ, weighted by the importance value Iᵢⱼ:

$${A}_{mn} = {\sum }_{∀ ( i , j )} {{I}_{ij} ( {B}_{ij} )}_{mn}$$

After this summation, the matrix A holds relative counts of importance for each basis vector in the DCT transform. This matrix is simply inverted and scaled entry-wise such that \overline{A}ₘₙ=max(Aₘₙ)/Aₘₙ. In the cases where Aₘₙ is zero, \overline{A}ₘₙ is set to 255, which is the largest allowable value for an 8 bit number. The values in \overline{A}ₘₙ are then scaled such that the squared error between \overline{A}ₘₙ and the standard JPEG quantization matrix is minimized. The quantization matrix Q is then set equal to this scaled matrix. Note that this process is only performed on the AC coefficients, in other words for all values of (m, n) except (0, 0). For the (0, 0) entry, Q₀₀ is simply initialized to the corresponding value in the standard JPEG quantization table.

Each block Bᵢⱼ is DCT transformed at step 48 according to the JPEG standard to produce DCT coefficients Dᵢⱼ.

For each block Bᵢⱼ in the image, a value Sᵢⱼ is calculated at step 50 where Sᵢⱼ=Iᵢⱼ*(Sₘₐₓ−Sₘᵢₙ)+Sₘᵢₙ. The parameters Sₘₐₓ and Sₘᵢₙ are user specified and in effect define the bounds over which the image will be variably quantized. This method is preferably used to remove redundant data from an existing compressed JPEG by letting Sₘᵢₙ be equal to the actual scaling value used in compressing the image originally, and using a user-defined value for Sₘₐₓ.

Each block Bᵢⱼ in the image is “pseudo-quantized” at step 56 with the quantization table Qₘₙ*Sᵢⱼ. This pseudo-quantization in effect emulates variable quantization. If one lets Dᵢⱼ be the original unquantized DCT transformed image block, and Tᵢⱼ the quantized DCT transformed block at step 54, then the algorithm for the pseudo-quantization can be described as given next.

The algorithm has three distinct quantization steps. In the first step, the coefficients in the block Bᵢⱼ are quantized using the standard JPEG quantization function with Sₘᵢₙ as the scaling value:

for each block Dᵢⱼ do

for each coefficient Dᵢⱼₘₙ in block Dᵢⱼ do

Tᵢⱼₘₙround(Dᵢⱼₘₙ/(Qₘₙ*Sₘᵢₙ))

where round denotes rounding to the nearest integer.

In the next step, if any coefficient Tᵢⱼₘₙ is >0, then

if round(Dᵢⱼₘₙ/(Qₘₙ*Sᵢⱼ))=0 then Tᵢⱼₘₙ=0

In the third and final step, if Tᵢⱼ is still greater than zero, and if the coefficient can be rounded down by one logarithm base-2 and not exceed the rounding error introduced by the quantization with the local quantization able, then it is so rounded down:

if(abs(Dᵢⱼₘₙ)−(2ˆ (ceil(lg(abs(Dᵢⱼₘₙ)+1))−1)−1))<=abs(Dᵢⱼₘₙ−Qₘₙ*Sᵢⱼ*round(Dᵢⱼₘₙ/(Qₘₙ*Sᵢⱼ)))

then

Tᵢⱼ=sign(Dᵢⱼₘₙ)*(2ˆ (ceil(lg(abs(Dᵢⱼₘₙ)+1))−1)−1)

In the above calculations, Qₘₙ*round(Dᵢⱼₘₙ/(Sᵢⱼ*Qₘₙ)) is the reconstructed coefficient after quantization by the local quantization table, and

abs(Dᵢⱼₘₙ−Qₘₙ*Sᵢⱼ*round(Dᵢⱼₘₙ/(Sᵢⱼ*Qₘₙ)))

is the absolute error introduced by quantization. Furthermore,

ceil(lg(abs(Dᵢⱼₘₙ)+1))

is the logarithm base-2 of the magnitude of the coefficient, and,

(2ˆ (ceil(lg(abs(Dᵢⱼₘₙ)+1))−1)−1)

is the magnitude of the coefficient rounded down by a logarithm base-2.

Thus,

abs(Dᵢⱼₘₙ)−(2ˆ (ceil(log(abs(Dᵢⱼₘₙ)+1))−1)−1)

is the absolute error introduced by rounding down by one logarithm base-2.

The algorithm in its entirety is:

for each block Dᵢⱼ do

{

for each coefficient Dᵢⱼₘₙ in block Dᵢⱼ do
{

Tᵢⱼₘₙ = round(Dᵢⱼₘₙ/(Sₘᵢₙ*Qₘₙ))
if Tᵢⱼₘₙ > 0 then
{

if round(Dᵢⱼₘₙ/(Sᵢⱼ*Qₘₙ)) = 0 then Tᵢⱼₘₙ = 0
else
{
if (abs(Dᵢⱼₘₙ) − (2\hat{ }(ceil(lg(abs(Dᵢⱼₘₙ)+1))−1)−1)) <=
abs(Dᵢⱼₘₙ − Qₘ*Sᵢⱼ * round(Dᵢⱼₘₙ/(Sᵢⱼ*Qₘₙ)))
then
Tᵢⱼₘₙ = sign(Dᵢⱼₘₙ) * (2\hat{ }(ceil(lg(abs(Dᵢⱼₘₙ)+1))−1)−1)
}

}

}

}

The above pseudo-code has the effect of zeroing any coefficients that would have been zeroed if Dᵢⱼₘₙ were quantized with Qₘₙ*Sᵢⱼ, but were not zeroed when quantized with Qₘₙ*Sₘᵢₙ. Also, it rounds down in magnitude (by one power of two) any coefficient that may be so rounded and not introduce more relative error in reconstruction than if that coefficient were truly quantized by Qₘₙ*Sᵢⱼ. This has the net effect of pseudo-quantizing Dᵢⱼ with Q*Sᵢⱼ, while actually quantizing the coefficients with Q*Sₘᵢₙ.

Finally, the quantized blocks Tᵢⱼₘₙ and the global quantization table Q*Sₘᵢₙ are entropy encoded at step 58 to create a JPEG image file 60 in accordance with the JPEG algorithm while still producing a fully compliant JFIF stream.

It should be noted that the algorithm is particularly useful in optimizing JPEG images that have already been quantized using the standard JPEG quantization table at a level Sₘᵢₙ. By definition Sᵢⱼ>=Sₘᵢₙ, hence the algorithm guarantees that the optimized JPEG will never be larger in size than the original JPEG, and will in almost all instances be smaller. At the same time the pseudo-quantization ensures that the image quality remains essentially unchanged to the human observer.

For the sake of clarity, the algorithm has been presented assuming the image contains a single 8-bit channel per pixel, in other words it is a greyscale image. However, the algorithm is easily extended to full color (3 channel) images, and more generally, n channel images with few adjustments to the process. In general, the algorithm is simply applied to each channel independently, where the visual importance values are calculated on the luminance channel. A single quantization matrix Q can be employed for all channels, or alternatively, a separate quantization matrix can be used for each channel. Likewise, Sₘᵢₙ and Sₘₐₓ can either be the same for all channels, are vary from channel to channel.

It is common practice to sub-sample one or more channels when color images are coded. The algorithm can still be employed in this case. An example using a full color, 3-channel image will be described.

A common color scheme to represent a color image is know as YUV. Here, Y stands for the luminance channel (or the greyscale data), and U and V are the blue and red chrominance (color) channels respectively. Since the human visual system perceives luminance information much better than color data, the U and V channels are typically sub-sampled by an integer factor, normally 2, to improve compression. In this case, in the original pixel domain the image is shrunk to half its original size, and then DCT transformed. When decoding, the inverse transform is applied and the plane is expanded by twice its size before merging the three channels to reconstruct the original image.

Because of the subsampling, there may be up to four Y channel blocks that correspond to the same region of an image covered by one U and V block. In this case, the visual importance Iᵢⱼ that is used is simply given as,

max{all corresponding Iᵢⱼ values from the Y channel}.

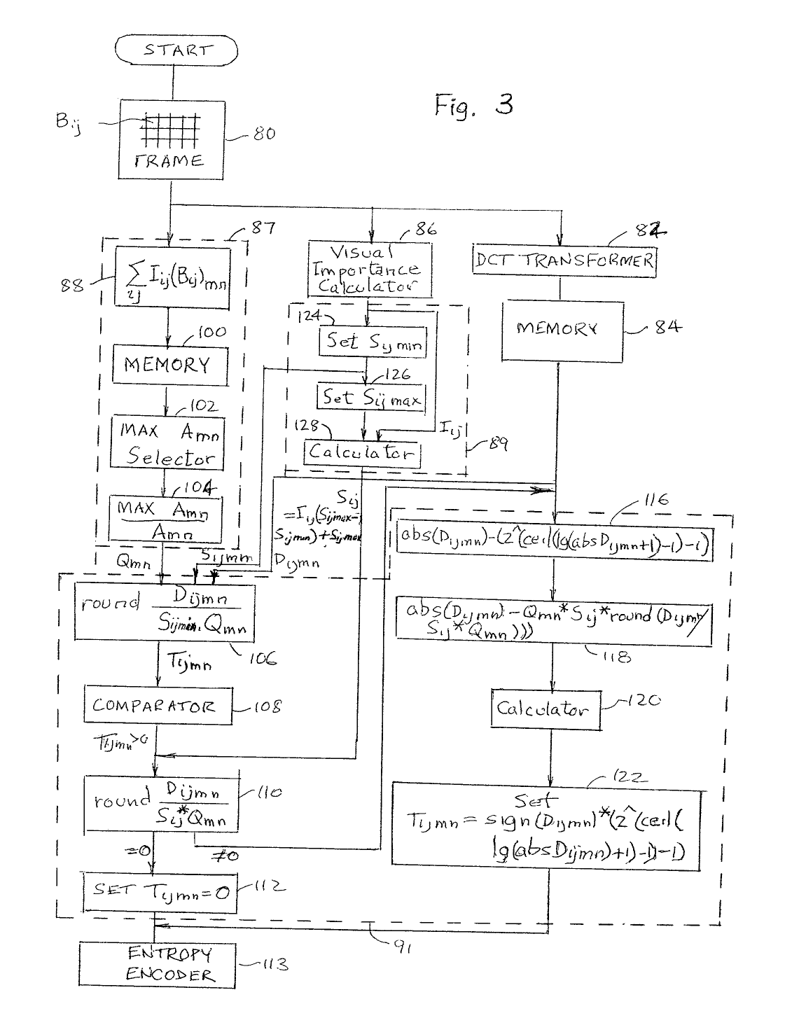

Referring to FIG. 3 the apparatus for JPEG Compression using the above algorithm consists of a frame grabber 80 into which non-overlapping, tiled, 8×8 image pixel blocks Bᵢⱼ are stored temporarily. Each block, Bᵢⱼ, the digital cosine transform (DCT) is calculated by DCT transformer 82 and the resultant transform coefficients Dᵢⱼₘₙ stored in memory 84. A visual importance calculator 86 calculates values of the visual importance, Iᵢⱼ, for each block Bᵢⱼ. A global quantization calculator 87 calculates elements Qᵢⱼ of a global quantization matrix utilizing, Iᵢⱼ, and Bᵢⱼ. A linear scaling factor calculator 89 uses user set values of Sᵢⱼₘᵢₙ and Sᵢⱼₘₐₓ set in blocks 124 and 126, respectively, and Iᵢⱼ to determine Sᵢⱼ in calculator 128 for quantized blocks Tᵢⱼ.

More particularly, values of the quantization matrix Qᵢⱼ are calculated by first forming the sum of the product of the visual importance Iᵢⱼ and the elements of Bᵢⱼ in block 88 to form the elements Aₘₙ in an 8×8 array which are stored in memory 100. The maximum value “Max Aₘₙ” in the array is selected by Max Aₘₙ selector 102. The elements Qₘₙ of the quantization matrix Q are calculated as (Max Aₘₙ)/Aₘₙ in block 104.

In block 106, the quotient of Dᵢⱼₘₙ/(Sᵢⱼₘᵢₙ*Qₘₙ) is rounded to the nearest integer yielding elements Tᵢⱼₘₘ. In comparator 108, the calculated value of Tᵢⱼₘₙ is compared with zero and, if greater than zero, in block 110 the quotient Dᵢⱼₘₙ/(Sᵢⱼ*Qₘₙ)is calculated and then rounded to the nearest integer. If the quotient Dᵢⱼₘₙ/(Sᵢⱼ*Qₘₙ) equals zero, then Tᵢⱼₘₙ is set equal to zero at block 112. If the quotient Dᵢⱼₘₙ/(Sᵢⱼ*Qₘₙ) is not equal to zero, at block 110, then the value of the rounded value of the latter quotient is transferred to block 116. Values calculated in blocks 116 and 118 are compared in calculator 120 and if the value calculated in block 116 is less than or equal to the value calculated in block 118, then the value of Tᵢⱼₘₙ is set equal to sign(Dᵢⱼₘₙ)*(2ˆ (ceil(lg(absDᵢⱼₘₙ)+1)−1)−1). The blocks of quantized coefficients Tᵢⱼ and the global quantization table Q*Sₘᵢₙ are entropy encoded by entropy encoder 113.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as they fall within the true scope of the invention.

We claim:

1. A method of JPEG compression of an image frame divided up into a plurality of non-overlapping, tiled 8×8 pixel blocks Bᵢⱼ where i, j are integers covering all of the blocks in the image frame, comprising:
(a) forming a discrete cosine transform (DCT) of each block Bᵢⱼ of the image frame to produce a matrix of blocks of transform coefficients Dᵢⱼ;
(b) calculating a visual importance, Iᵢⱼ, for each block of the image, based upon assigning zeros for flat features and values approaching unity for sharply varying features;
(c) forming a global quantization matrix Q by one of
(i) selecting a standard JPEG quantization table and
(ii) selecting a quantization table such that the magnitude of each quantization matrix coefficient Qᵢⱼ is inversely proportional to the importance in the image of the corresponding DCT basis vector; and
(d) selecting a linear scaling factor Sᵢⱼ defining bounds over which the image is to be variably quantized;
(e) quantizing the transform coefficients, Dᵢⱼₘₙ, by an equivalent of dividing them by a factor Sₘᵢₙ*Q, where Sₘᵢₙ is a user selected minimum scaling factor, and
(f) entropy encoding quantized coefficients Tᵢⱼₘₙ and Q*Sₘᵢₙ to create a JPEG image file.

2. A method according to claim 1, wherein step (e) includes rounding (Dᵢⱼₘₙ/(Sₘᵢₙ*Q)) to the nearest integer to form quantized DCT transformed coefficients Tᵢⱼₘₙ;
(a) setting Tᵢⱼₘₙ=0 if round (Dᵢⱼₘₙ/(Qₘₙ*Sᵢⱼ)=0; and
(b) setting Tᵢⱼₘₙ=sign(Dᵢⱼₘₙ)*(2ˆ (ceil(lg(abs(Dᵢⱼₘₙ)+1))−1)−1) if abs(Dᵢⱼₘₙ)−(2ˆ (ceil(lg(abs(Dᵢⱼₘₙ)+1))−1)−1) is less than or equal to abs(Dᵢⱼₘₙ−QₘₙSᵢⱼ*round(Dᵢⱼₘₙ/(Sᵢⱼ*Qₘₙ)));

3. A method according to claim 1, including calculating a linear scaling factor Sᵢⱼ equal to Iᵢⱼ*(Sₘₐₓ−Sₘᵢₙ)+Sₘᵢₙ where Sₘᵢₙ and Sₘₐₓ are user specified to define bounds over which the image will be variably quantized.

4. The method according to claim 1, where Iᵢⱼ is determined by discrete edge detection and summation of transform coefficients.

5. The method according to claim 1, wherein Iᵢⱼ is determined by creating a 24×24 matrix of image pixels of DCT coefficients centered on a block Bᵢⱼ, where i and j=1, 2, . . . 8, convolving said 24×24 matrix with an edge tracing kernel to produce a convolved matrix, summing center 10×10 matrix values of said convolved matrix to produce a summed value, and normalizing said summed value to produce a visual importance, Iᵢⱼ.

6. The method according to claim 1, wherein said Q is formed by calculating an 8×8 matrix A by calculating matrix elements Aₘₙ of said A according to the formula
$${A}_{mn} = {\cdot }_{( i , j )} {{I}_{ij} ( {B}_{ij} )}_{mn} ,$$
calculating elements Qₘₙ of said Q according to the formula
Qₘₙ=max(Aₘₙ)/Aₘₙ
and scaling values of Qₘₙ for all values of (m, n) except (0, 0) in order to minimize an error between Q and a standard JPEG quantization matrix.

7. A method of JPEG compression of an image frame divided up into a plurality of non-overlapping, tiled 8×8 pixel blocks Bᵢⱼ where i, j are integers covering all of the blocks in the image frame, comprising:
(a) forming a discrete cosine transform (DCT) of each block Bᵢⱼ of the image frame to produce a matrix of blocks of transform coefficients Dᵢⱼ;
(b) calculating a visual importance, Iᵢⱼ, for each block of the image, based upon assigning zeros for flat features and values approaching unity for sharply varying features;
(c) forming a global quantization matrix Q by one of
(i) selecting a standard JPEG quantization table and
(ii) selecting a quantization table such that the magnitude of each quantization matrix coefficient Qᵢⱼ is inversely proportional to a visual importance, Iᵢⱼ, to the image of a corresponding DCT basis vector; and
(d) selecting a linear scaling factor Sᵢⱼ defining bounds over which the image is to be variably quantized wherein Sᵢⱼ=lᵢⱼ(Sₘₐₓ−Sₘᵢₙ)+Sₘᵢₙ, where Sₘₐₓ and Sₘᵢₙ are user selected;
(e) quantizing the transform coefficients, Dᵢⱼₘₙ, to produce quantized blocks Tᵢⱼₘₙ as follows:
(i) Tᵢⱼₘₙ=round(Dᵢⱼₘₙ/(Sₘᵢₙ*Qₘₙ)), where round denotes rounding to the nearest integer;
(ii) setting Tᵢⱼₘₙ=0 if round(Dᵢⱼₘₙ/(Qₘₙ*Sᵢⱼ))=0; and
(iii) setting Tᵢⱼₘₙ=sign(Dᵢⱼₘₙ)*(2ˆ (ceil(lg(abs(Dᵢⱼₘₘ)+1))−1)−1) if abs(Dᵢⱼₘₙ)−(2ˆ (ceil(lg(abs(Dᵢⱼₘₙ)+1))−1)−1) is less than or equal to (abs(Dᵢⱼₘₙ−Qₘₙ*Sᵢⱼ*round(Dᵢⱼₘₙ/(Sᵢⱼ*Qₘₙ))));
(f) entropy encoding quantized coefficients Tᵢⱼₘₙ and Q*Sₘᵢₙ, to create a JPEG image file.

8. A method of JPEG compression of a colour image represented by channels Y for greyscale data, and U and V each for colour, comprising:
(a) shrinking the colour channels U and V by a fraction of their size;
(a) forming a discrete cosine transform (DCT) Dᵢⱼ for each block Bᵢⱼ of each of channels Y, U and V;
(b) calculating a visual importance, Iᵢⱼ, for each Y channel block of each image and setting Iᵢⱼ=max{Iᵢⱼ values for corresponding Y channel blocks} for blocks in the U and V channels;
(c) forming a global quantization matrix Q for the Y channel block and one for channels U and V combined such that a magnitude of each quantization matrix coefficient Qᵢⱼ is inversely proportional to an importance in the image of a corresponding DCT basis vector; and
(d) quantizing the transform coefficients for each of the Y, U and V channels by dividing them by a factor Sᵢⱼ Q′, where Sᵢⱼ is a linear scaling factor for each of channels Y, U and V and Q′ is the quantization table for the associated channel being quantized; and
(e) entropy encoding quantized coefficients Tᵢⱼₘₙ and Q′*Sₘᵢₙ, where Sₘᵢₙ is a user selected minimum scaling factor for each of channels Y, U, and V, to create a JPEG image file for each of channels Y, U and V.

9. The method of claim 8 wherein the shrinking factor is ½.

10. Apparatus for JPEG compression of an image frame divided up into a plurality of non-overlapping, tiled 8×8 pixel blocks Bᵢⱼ where i, j are integers covering all of the blocks in the image frame, comprising:
(a) a discrete cosine transformer (DCT) operative to form the deiscrete cosine transform of each block Bᵢⱼ of the image frame to produce a matrix of blocks of transform coefficients Dᵢⱼ;
(b) a visual importance calculator operative to calculate the visual importance, Iᵢⱼ, for each block of the image, based upon assigning zeros for flat features and values approaching unity for sharply varying features;
(c) a global quantization matrix calculator operative to calculate the global quantization matrix, Q, by one of
(i) selecting a standard JPEG quantization table and
(ii) selecting a quantization table such that the magnitude of each quantization matrix coefficient Qᵢⱼ is inversely proportional to the importance in the image of the corresponding DCT basis vector; and
(d) a linear scaling factor calculator operative to determine a linear scaling factor, Sᵢⱼ, defining bounds over which the image is to be variably quantized based on user established values of Sₘₐₓ and Sₘᵢₙ;
(e) a quantizer operative to divide the transform coefficients, Dᵢⱼₘₙ, by a value equivalent to dividing them by a factor Sₘᵢₙ*Q, where Sₘᵢₙ is a user selected minimum scaling factor, and
(f) an entropy encoder operative to encode the quantized coefficients Tᵢⱼₘₙ and Q*Sₘᵢₙ to create a JPEG image file.

11. Apparatus according to claim 10, wherein said quantizer rounds (Dᵢⱼₘₙ/(Sₘᵢₙ*Q)) to the nearest integer to form quantized DCT transformed coefficients Tᵢⱼₘₙ and
(a) sets Tᵢⱼₘₙ=0 if round(Dᵢⱼₘₙ/(Qₘₙ*Sᵢⱼ)=0; and
(b) sets Tᵢⱼₘₙ=sign(Dᵢⱼₘₙ)*(2ˆ (ceil(lg(abs(Dᵢⱼₘₙ)+1))−1)−1) if abs(Dᵢⱼₘₙ)−(2ˆ (ceil(lg(abs(Dᵢⱼₘₙ)+1))−1)−1) is less than or equal to abs(Dᵢⱼₘₙ−QₘₙSᵢⱼ*round(Dᵢⱼₘₙ/(Sᵢⱼ*Qₘₙ)));

12. Apparatus according to claim 10, wherein said linear scaling factor calculator determines a linear scaling factor Sᵢⱼ equal to Iᵢⱼ*(Sₘₐₓ−Sₘᵢₙ)+Sₘᵢₙ where Sₘᵢₙ and Sₘₐₓ are user specified to define bounds over which the image will be variably quantized.
